(19) United States
(12) Patent Application Publication
(10) Pub. No.: US 2010/0161742 A1
(43) Pub. Date: Jun. 24, 2010

(54) COMMUNICATION APPARATUS

(75) Inventor: Takushiro HANEDA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/481,714

(22) Filed: Jun. 10, 2009

(30) Foreign Application Priority Data
Dec. 19, 2008 (JP) P2008-324297

(51) Int. Cl. G06F 15/16

(52) U.S. Cl. 709/206; 455/466

(57) ABSTRACT

A communication apparatus including: an input module configured to receive input of figures and/or characters; a communication module configured to send and receive an e-mail; a memory configured to store an e-mail created by using the input module; and a controller configured to read, from the memory, a first reply mail that is a reply mail to a first reception mail received by the communication module and to add the read-out first reply mail to a second reply mail in creating the second reply mail as a reply mail to a second reception mail that is received before sending the first reply mail, if a source address or a destination address of the first reception mail is included in a source address or a destination address of the second reception mail.

### CROSS-REFERENCE TO RELATED APPLICATIONS

The entire disclosure of Japanese Patent Application No. 2008-324297 filed on Dec. 19, 2008, including specification, claims, drawings and abstract is incorporated herein by reference in its entirety.

### BACKGROUND

1. Field of the Invention

One aspect of the invention relates to a communication apparatus which has a communication function and, in particular, sends and receives an e-mail.

2. Description of the Related Art

In recent years, with the size and weight reduction of communication apparatuses and the spread of wireless communication lines, communication apparatuses having a wireless communication function have been spreading. Incorporating a data communication function in addition to a voice communication function (telephone function), communication apparatuses having a wireless communication function are being used for various purposes such as transmission/reception of an e-mail (hereinafter referred to simply as a mail), browsing of websites on the Internet, and trading of goods (e.g., Internet shopping). And, in particular, techniques relating to the mail transmission/reception among the above functions have been developed enthusiastically: cell phones having various functions relating to the mail transmission/reception such as a reply function of creating a reply mail directed to a sender of a mail received and a storage function of temporarily storing a mail being created have been put into practical use.

Among publicized techniques relating to the mail transmission/reception is a technique for displaying a reception mail as part of a mail edit screen, which makes it possible to create a reply mail while referring to the contents of the reception mail (see JP-A-2007-110464, for instance). Another technique is laid open which serves to telop-display a reception mail on the screen upon its reception (see JP-A-2003-150506, for instance).

As for the creation of a mail, when a mail is received from another communication apparatus, it is a frequently employed procedure to create a reply mail by setting the source address of the reception mail as the destination address of the reply mail. In this case, to create a reply mail that reflects the contents of the reception mail, in many cases part of the reception mail is cited in the reply mail or the reply mail is created while the reception mail is referred to (as described in JP-A-2007-110464).

There may occur a case that a new mail is received from the sender of a reception mail while a reply mail is being created or a case that a new mail is received from another communication apparatus that received the same mail while a reply mail is being created. In such a case, if it is attempted to reply to the new reception mail, reply mail sentences that were written previously are discarded and it becomes necessary to create a new reply mail from the start. That is, every time a new mail is received, the user is required to create, from the start, a new reply mail that reflects the contents of related mails so far received. This means loss of convenience.

### SUMMARY

According to an aspect of the invention, there is provided a communication apparatus including: an input module configured to receive input of figures and/or characters; a communication module configured to send and receive an e-mail; a memory configured to store an e-mail created by using the input module; and a controller configured to read, from the memory, a first reply mail that is a reply mail to a first reception mail received by the communication module and to add the read-out first reply mail to a second reply mail in creating the second reply mail as a reply mail to a second reception mail that is received before sending the first reply mail, if a source address or a destination address of the first reception mail is included in a source address or a destination address of the second reception mail.

### BRIEF DESCRIPTION OF THE DRAWINGS

Embodiment may be described in detail with reference to the accompanying drawings, in which:

FIGS. 1A and 1B show an exemplary appearance of a folding-type cell phone which is an example cell phone according to an embodiment of the present invention;

FIGS. 2A and 2B show another appearance of the folding-type cell phone shown in FIG. 1;

FIG. 3 is an exemplary block diagram showing an internal configuration of the cell phone according to the embodiment;

FIG. 4 is an exemplary conceptual diagram showing how networks connect a transmission-side cell phone and a reception-side cell phone in the embodiment.

FIG. 5 is an exemplary flowchart of a process according to the embodiment of the invention in which a past, incomplete reply mail is cited in creating a reply mail; and

FIG. 6 shows exemplary pictures which are displayed on a main display of the transmission-side cell phone according to the embodiment of the invention.

### DETAILED DESCRIPTION OF THE EMBODIMENTS

An embodiment of the present invention will be hereinafter described with reference to the drawings.

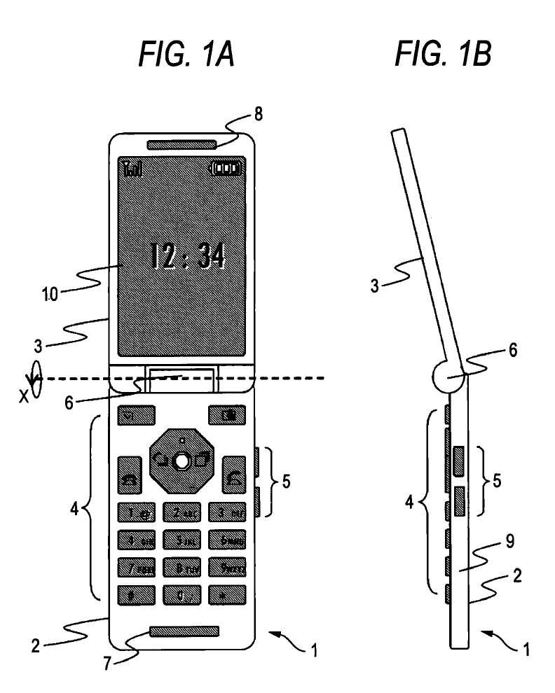

FIGS. 1A and 1B show an appearance of a folding-type cell phone 1 which is an example of the cell phone according to the invention. FIG. 1A is a front view of the cell phone 1 which is opened so as to form approximately 180°, and FIG. 1B is a side view of the cell phone 1 in the same open state.

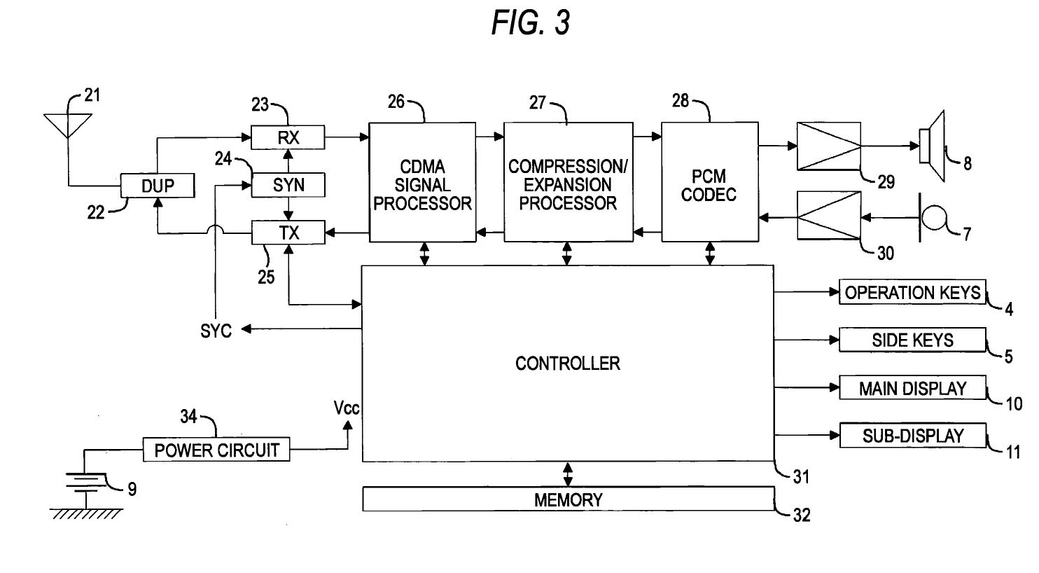

As shown in FIGS. 1A and 1B, the cell phone 1 is configured so that a first body 2 and a second body 3 are connected to each other by a central hinge 6; the cell phone 1 is able to be folded in a direction indicated by arrow X through the hinge 6. A transmission/reception antenna (i.e., an antenna 21 shown in FIG. 3 (described later)) is provided at a given position inside the cell phone 1. The cell phone 1 exchanges radio waves with a radio base station 84 (described layer) via the built-in antenna.

The front of the first body 2 is provided with operation keys 4 which are numeral keys of “0” to “9,” a transmission/reception key, a redial key, a call ending/power key, a clear key, a first menu key, etc. Furthermore, one side of the first body 2 is provided with side keys 5 which are a manner mode key, a second menu key, etc. The user inputs various instructions and data to the cell phone 1 using the operation keys 4 and the side keys 5. The operation keys 4 and the side keys 5 are generically referred to as input module 40.

The first body 2 is equipped with a microphone 7 under the operation keys 4 (as shown in FIG. 1); a voice of the user is picked up by the microphone 7 during a call.

The first body 2 is equipped with a battery 9 on the back side; the battery 9 supplies power to individual circuit sections (described later) when the cell phone 1 is turned on by the call ending/power key being pressed for a long time.

On the other hand, the second body 3 is equipped with a main display 10 on the front; a setting screen of the cell phone 1, a mail, a website content, etc. can be displayed on the main display 10. For example, the main display 10 is a liquid crystal display (LCD) or an organic electroluminescence (EL) display. A receiver 8 is disposed above the main display 10 (as shown in FIG. 1); the user can hear a transmitted voice of a counterpart party with the receiver 8.

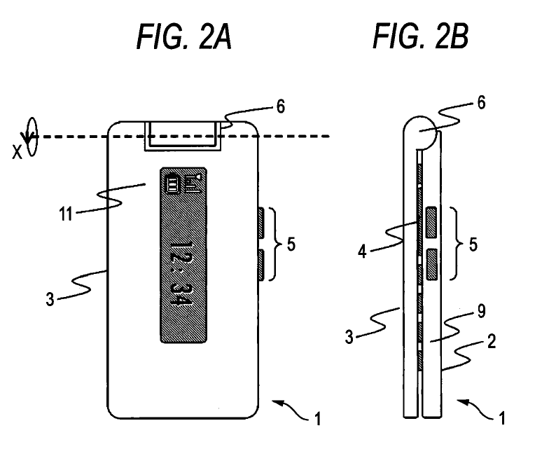

FIGS. 2A and 2B show an appearance of the folding-type cell phone 1 in a folded state. FIG. 2A is a front view of the cell phone 1 which is closed, and FIG. 2B is a side view of the cell phone 1 in the same closed state.

The second body 3 is equipped with a sub-display 11 (e.g., LCD) on the front side. For example, an antenna pictograph indicating the intensity level of radio waves being received by the cell phone 1, a battery pictograph indicating the residual energy of the battery 9, a present time, etc. are displayed on the sub-display 11. The side keys 5 provided on the first body 2 are disposed at such positions that they can be manipulated even when the cell phone 1 is in the closed state.

FIG. 3 is a block diagram showing the internal configuration of the cell phone 1 according to the embodiment.

A radio signal transmitted from a radio base station 84 (described later) is received by an antenna 21 and input to a receiving circuit (RX) 23 via an antenna duplexer (DUP) 22. The received radio signal is mixed, by the receiving circuit 23, with a local oscillation signal that is output from a frequency synthesizer (SYN) 24, and is thereby down-converted into an intermediate frequency signal.

The intermediate frequency signal produced by the down conversion is demodulated by the receiving circuit 23 and output as a reception baseband signal.

The reception baseband signal which is output from the receiving circuit 23 is input to a code division multiple access (CDMA) signal processor 26. The CDMA signal processor 26 is equipped with a rake receiver (not shown). In the rake receiver, signals of plural paths which are included in the reception baseband signal are subjected to inverse spreading using respective spreading codes (identical to spreading codes of the spread reception signals). The inverse-spread signals of the respective paths are subjected to phase rotation and coherent rake combining. A data sequence produced by the rake combining is subjected to deinterleaving and channel decoding (error correction decoding) and then to binary data determination. In this manner, the CDMA signal processor 26 creates reception packet data having a given transmission format, which is input to a compression/expansion processor 27. The CDMA signal processor 26 is implemented as a digital signal processor (DSP).

In the compression/expansion processor 27, the reception packet data that is output from the CDMA signal processor 26 is separated into signals corresponding to respective media such as an audio signal and a data signal by a demultiplexing section (not shown). The signals corresponding to the respective media are decoded individually. On the other hand, each of a digital audio signal that is output from a PCM codec 28 and a data signal that is output from a controller 31 is compression-coded according to a format corresponding to a given transmission data rate. The resulting compression-coded signals are multiplexed according to a given transmission format by a multiplexing section (not shown) and then converted into packets. The resulting transmission packets are output to the CDMA signal processor 26.

An audio signal of the user that is output the microphone 7 is amplified to a proper level by a transmitter amplifier 30 and PCM-coded by the PCM codec 28. The resulting PCM-coded digital audio signal is input to the compression/expansion processor 27. A data signal of a mail, for example, created by the controller 31 is also input to the compression/expansion processor 27.

The CDMA signal processor 26 performs spectrum spreading on the transmission packet data that is output from the compression/expansion processor 27 and thereby creates a spread signal. The spectrum spreading is performed by using a spreading code that is assigned to a transmission channel. The spread signal created by the CDMA signal processor 26 is output to a transmission circuit (TX) 25. The transmission circuit 25 modulates the spread signal according to a digital modulation method such as quadrature phase shift keying (QPSK). Furthermore, the transmission circuit 25 combines the spread signal with a local oscillation signal created by the frequency synthesizer 24, and thereby up-converts it into a radio signal. The transmission circuit 25 amplifies the radio signal as up-converted so as to satisfy a transmission power level that is specified by the controller 31. The amplified radio signal is supplied to the antenna 21 via the antenna duplexer 22 and sent to the radio base station 84 (described later) from the antenna 21.

A power circuit 34 provided in the cell phone 1 supplies the above-described individual circuit sections with a given operation power supply voltage Vcc that is created by performing an analog-to-digital conversion on an output analog voltage of the battery 9.

The controller 31 includes such electronic circuits as a central processing unit (CPU), a read-only memory (ROM), and a random access memory (RAM). The CPU performs various kinds of processing according to programs stored in the ROM or various application programs loaded into the RAM. Furthermore, the CPU processes signals supplied from the above-described respective circuit sections, and creates various control signals and supplies them to the individual circuit sections. The CPU supervises the cell phone 1 by performing those kinds of processing. Data that are necessary for the CPU's performing various kinds of processing are stored in the RAM. The controller 31 is equipped with a video RAM (not shown), which stores information relating to video that is displayed on the main display 10. A memory 32 is, for example, a flash memory which is an electrically rewritable and erasable nonvolatile memory or a hard disk drive (HDD). The memory 32 is stored with various application programs to be executed by the CPU of the controller 31 and related data groups.

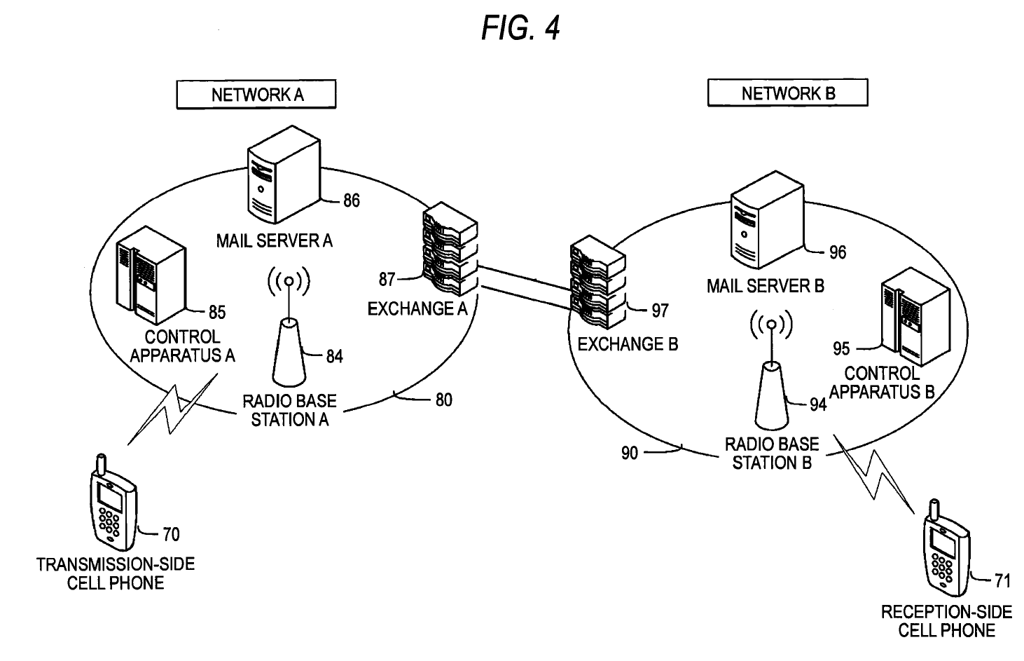

FIG. 4 shows an example mail transmission/reception mechanism and, more specifically, is a conceptual diagram showing how networks A (80) and B (90) connect a mail-transmission-side cell phone 70 and a mail-reception-side cell phone 71. Each of the networks A (80) and B (90) includes at least an exchange A (87) or B (97), a mail server A (86) or B (96), a radio base station A (84) or B (94), and a control apparatus A (85) or B (95).

Each of the radio base stations A (84) and B (94) modulates a wired signal flowing from one of the networks A (80) and B (90) to the other into a radio signal and sends it to the cell phone 70 or 71, for example, and demodulates a radio signal transmitted from the cell phone 70 or 71, for example, into a wired signal and sends it to inside the network A (80) or B (90).

The exchanges A (87) and B (97) design a circuit route to a mail destination based on destination information of a mail sent. Furthermore, according to the designed circuit route, the exchanges A (87) and B (97) perform what is called circuit switching for switching circuit connections between the network A (80) and B (90) and the exchanges A (87) and B (97).

Each of the control apparatus A (85) and B (95) holds pieces of presence information of communication apparatuses including the cell phone 70 or 71 that are located in the network A (80) or B (90). Furthermore, each of the control apparatus A (85) and B (95) holds information that correlates the communication apparatuses including the cell phone 70 or 71 that are located in the network A (80) or B (90) and the mail server A (86) or B (96) that provides mail services to those communication apparatuses.

When a mail has been transmitted to one of the communication apparatuses including the cell phone 70 or 71 that are located in the network A (80) or B (90) to which the mail server A (86) or B (96) belongs, the mail server A (86) or B (96) stores the transmitted mail temporarily. Furthermore, each of the mail servers A (86) and B (96) sends mail data to the cell phone 70 or 71, for example, in response to a mail data transmission request from the control apparatus A (85) or B (86).

### (Mail Transmitting Operation)

A description will be made of an operation that is performed when the transmission-side cell phone 70 which belongs to the network A (80) sends a mail to the reception-side cell phone 71 which belongs to the network B (90).

First, mail sending operations are performed on the transmission-side cell phone 70 in such a manner that the address of the reception-side cell phone 71 is designated as a destination address. The transmission-side cell phone 70 converts a mail into radio packet data and sends the radio packet data to the radio base station A (84). The radio base station A (84) demodulates the received radio packet data and sends the demodulated wired packet data (hereinafter referred to simply as the mail) to the control apparatus A (85). The control apparatus A (85) checks the address of the network B (90) to which the reception-side cell phone 71 currently belongs whose address is set as the destination address of the received mail. Recognizing the address of the network B (90), the control apparatus A (85) sends a signal for inquiring the address of the mail server B (96) to the control apparatus B (95) which belongs to the network B (90).

Receiving the address inquiry signal, the control apparatus B (95) sends the address information of the mail server B (96) to the control apparatus A (85). Based on the received address information, the control apparatus A (85) designs a circuit route that connects the control apparatus A (85) and the mail server B (96). As for the designing of a circuit route, usually, communication costs are set for respective circuits in advance and open shortest path fast (OSPF) is used, which is a protocol for selecting a route that minimizes the sum of communication costs of a circuit route. After designing the circuit route, the control apparatus A (85) sends the mail to the exchange A (87). The exchanges A (87) and B (97) perform circuit switching according to the designed circuit route and send the mail to the mail server B (96). The mail server B (96) stores the received mail on its own information storage medium.

Then, the reception-side cell phone 71 sends a mail reception instruction to the radio base station B (94) which is located in the network B (90). The radio base station B (94) sends the mail reception instruction to the mail server B (96). The mail server B (96) reads out the mail stored therein according to the mail reception instruction and sends it to the radio base station B (94). The radio base station B (94) sends the mail to the reception-side cell phone 71. The mail is sent and received by the above operation.

Although in the above description the radio base stations A (84) and B (94), the control apparatus A (85) and B (95), the mail servers A (86) and B (96), and the exchanges A (87) and B (97) are separate apparatuses, some of these apparatus may be combined into a single apparatus. For example, the control apparatus A (85) and the exchange A (87) may be combined into a single apparatus.

### (Mail Citing Operation at the Time of Sending a Reply Mail)

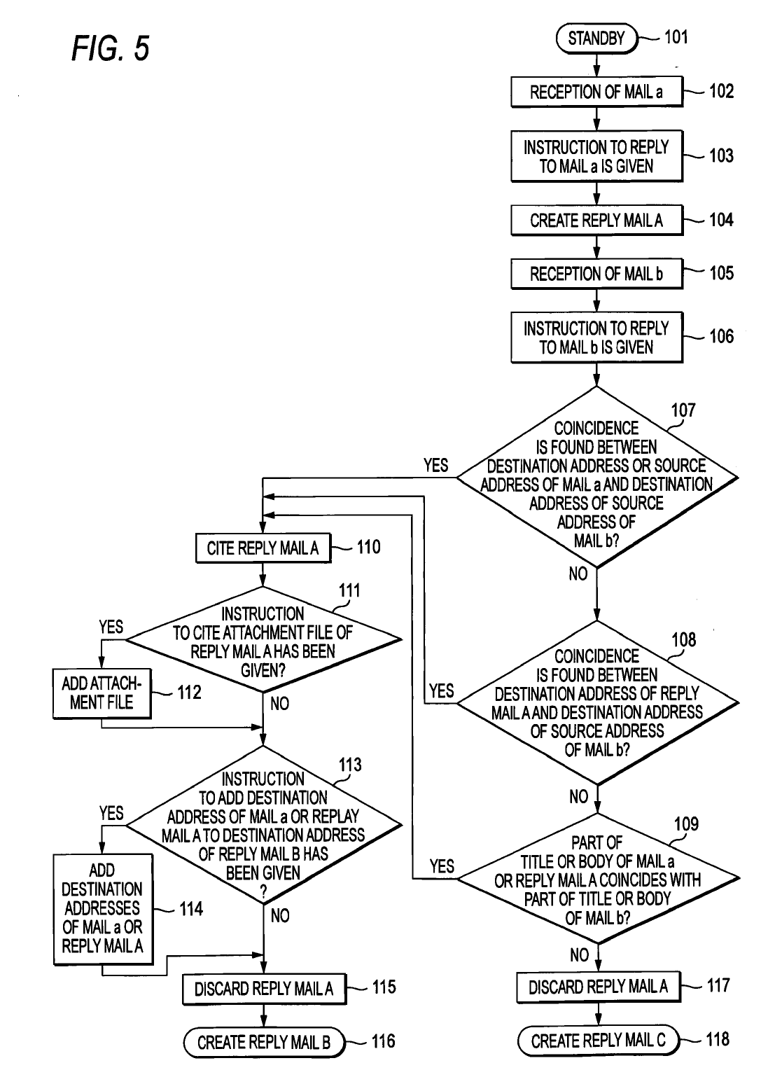

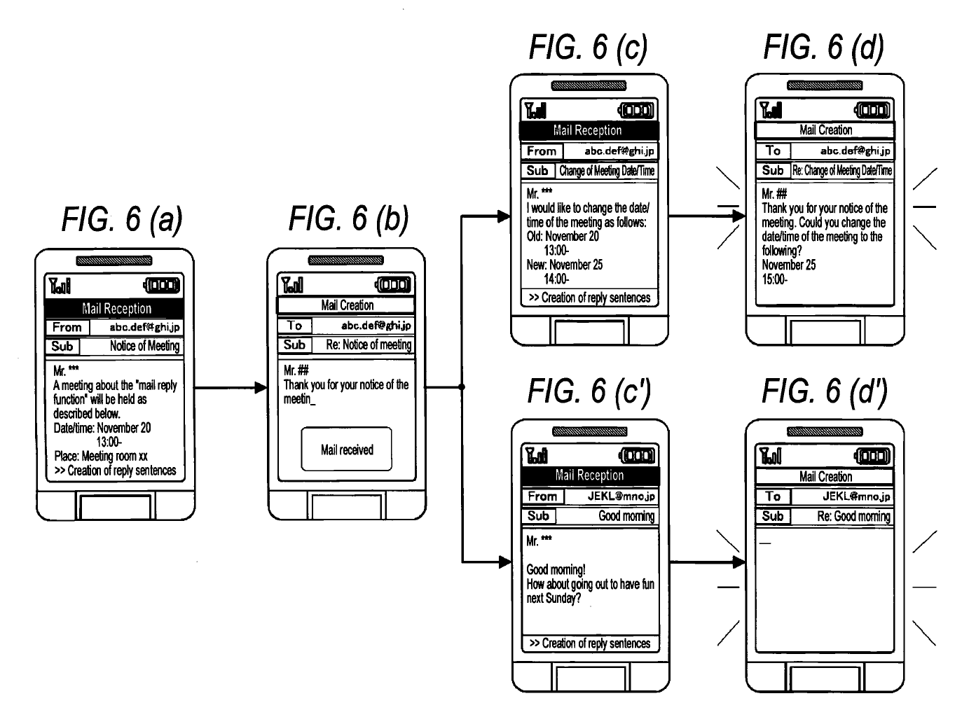

In the example of FIG. 5, assume that the controller 31 of the transmission-side cell phone 70 received a mail a and has received a new mail b in the midst of creating a reply mail A to the reception mail a or immediately after completion of a reply mail A. For example, if the controller 31 has received a new mail b during an edit of the reply mail A, the user gives an instruction to reply to the new mail b through the operation keys 4. If the reception mail b relates to the reception mail a or the reply mail A, the controller 31 creates a new reply mail B by citing the reply mail A. For example, citing the reply mail A which is incomplete or has just been completed means that the body of the reply mail A is pasted to a screen for creation of the replay mail B. This dispenses with time and labor to input sentences from the start. FIG. 6 shows example display screens that are displayed on the main display 10 of the transmission-side cell phone 70 as mails are received or created. A detailed operation according to the embodiment will be described below with reference to FIGS. 5 and 6.

First, when the controller 31 of the transmission-side cell phone 70 which is in a standby state (step 101) receives a mail a that is transmitted from the radio base station A (84), at step 102 the controller 31 performs reception processing and displays the reception mail a on the main display 10 (refer to the picture of FIG. 6, section (a)).

If an instruction to reply to the reception mail a is given through the operation keys 4 while it is displayed (step 103), at step 104 the controller 31 switches to a screen for creation of a reply mail A in which the source address of the reception mail a is employed as a destination address.

In the process of creating a reply mail A, storage operations are performed on the RAM of the controller 31 in response to input operations (e.g., operations for selecting characters) through the operation keys 4. If the transmission-side cell phone 70 is informed of upcoming transmission of a new mail b by the radio base station A (84) and receives it during creation of the reply mail A or immediately after completion of the reply mail A (i.e., before sending of the reply mail A), at step 105 the controller 31 displays, on the main display 10, a message to the effect that the new mail b has been received (refer to the picture of FIG. 6, section (b)) and switches to a screen for display of the reception mail b (refer to the picture of FIG. 6, section (c)).

If an instruction to reply to the reception mail b is given through the operation keys 4 (step 106), the controller 31 determines whether the reception mail b relates to the reception mail a or the reply mail A.

This determination includes the following three determinations.

As the first determination, the controller 31 determines at step 107 whether a coincidence is found between the destination address or the source address of the reception mail a and the destination address or the source address of the reception mail b.

As the second determination, the controller 31 determines at step 108 whether a coincidence is found between the destination address of the reply mail A and the destination address or the source address of the reception mail b.

As the third determination, the controller 31 determines at step 109 whether part of the title or the body of the reception mail a or the reply mail A coincides with part of the title or the body of the reception mail b.

As for the third determination, in the example of FIG. 6, since the title of the reception mail a and that of the reception mail b are both “Notice of Meeting,” that is, they are identical, it may be determined that the reception mail a and the reception mail b relate to each other. Since the title of the reply mail A is “Re: Notice of Meeting” and that of the reception mail b is “Change of Meeting Date/time,” that is, the part “Meeting” is common to the two mails, it maybe determined that the reception mail A and the reception mail b relate to each other. Furthermore, the following procedure may be employed. Particles, auxiliary verbs, adverbs, etc. are removed from the bodies and the titles and only nouns are extracted from them. Then, nouns that appear in the bodies or the titles at high frequencies (e.g., nouns that appear in the mail bodies five times or more) are extracted from all the nouns extracted above. It is determined that the reception mail a and the reception mail b relate to each other if the two mails include the same noun that appear at a high frequency. Another possible procedure is to compare the bodies or the titles and to determine that the two mails relate to each other if their sentences coincide with each other at a threshold percentage or more (e.g., at 50% or more in terms of the number of characters).

If the controller 31 determines that the reception mail b relates to the reception mail a or the reply mail A by making the three determinations (one of steps 107-109: yes), at step 110 the controller 31 cites the reply mail A which is incomplete or has just been completed. The body of the reply mail A is pasted to a screen for creating a reply mail B that was displayed on the main display 10 in response to the instruction to reply to the reception mail b. The body of the reply mail A is pasted by the controller 31's copying data of the reply mail A (incomplete or just completed) that is stored in, for example, the RAM (temporary storage) to a memory area of the RAM for an edit of the reply mail B.

If the reply mail A which is incomplete or has just been completed has an attachment file and an instruction to cite the attachment file is given through the operation keys 4 (step 111: yes), at step 112 the controller 31 adds the attachment file to the reply mail B.

Although in the above description the attachment file is added in response to the instruction to do so which is given through the operation keys 4, the attachment file may be added at the same time as the body of the reply mail A is pasted.

The reception mail a or the reply mail A may be a broadcast mail in which plural destination addresses are specified. If an instruction to add the plural destination addresses that are set in the reception mail a or the reply mail A to the destination address of the reply mail B (step 113: yes), the controller 31 does so at step 114.

At step 115, the controller 31 deletes the data of the reply mail A (incomplete or just completed) that is stored in the RAM. Upon the deletion of the data, at step 116 the controller 31 switches to a screen for creating the reply mail B to which the body of the reply mail A is pasted (refer to the picture of FIG. 6, section (d)).

On the other hand, if the controller 31 determines that the reception mail b relates to neither the reception mail a nor the reply mail A (all of steps 107-109: no; refer to the picture of FIG. 6, section (c′)), at step 117 the controller 31 discards the reply mail A which is incomplete or has just been completed. At step 118, the controller 31 switches to a screen for creating a new reply mail C and the user creates a reply mail C using the operation keys 4 and the main display 10 (refer to the picture of FIG. 6, section (d′)).

In the above-described operation according to the embodiment, if a mail b is received during creation of a reply mail A to a reception mail a or immediately after completion of a reply mail A and the user starts creating another reply mail B, the controller 31 determines whether the reception mail b relates to the reception mail a or the reply mail A. If determining that the reception mail b relates to the reception mail a or the reply mail A, the controller 31 operates to cite of the reply mail A and pastes its body to a screen for creating the reply mail B. This dispenses with time and labor to create a reply mail B from the start.

Although the embodiment is directed to the cell phone, the scope of the invention is not limited to it. For example, the invention can also be applied to a personal digital assistant (PDA), a wired terminal, a small information processing apparatus, etc.

Although the embodiment is directed to the folding-type cell phone, the invention can also be applied to a slide-type portable terminal or a bar-type portable terminal having no movable mechanism.

The invention is not limited to the above embodiment itself and may be embodied in such a manner that elements are modified without departing from the spirit and scope of the invention. And various inventions may be conceived by properly combining plural elements disclosed in the embodiment. For example, several ones of the elements of the embodiment may be omitted.

What is claimed is:

1. A communication apparatus comprising:
an input module configured to receive input of figures and/or characters;
a communication module configured to send and receive an e-mail;
a memory configured to store an e-mail created by using the input module; and
a controller configured to read, from the memory, a first reply mail that is a reply mail to a first reception mail received by the communication module and to add the read-out first reply mail to a second reply mail in creating the second reply mail as a reply mail to a second reception mail that is received before sending the first reply mail, if a source address or a destination address of the first reception mail is included in a source address or a destination address of the second reception mail.

2. A communication apparatus comprising:
an input module configured to receive input of figures and/or characters;
a communication module configured to send and receive an e-mail;
a memory configured to store an e-mail created by using the input module; and
a controller configured to read, from the memory, a first reply mail that is a reply mail to a first reception mail received by the communication module and to add the read-out first reply mail to a second reply mail in creating the second reply mail as a reply mail to a second reception mail that is received before sending the first reply mail, if a destination address of the first reply mail is included in a source address or a destination address of the second reception mail.

3. A communication apparatus comprising:
an input module configured to receive input of figures and/or characters;
a communication module configured to send and receive an e-mail;
a memory configured to store an e-mail created by using the input module; and
a controller configured to read, from the memory, a first reply mail that is a reply mail to a first reception mail received by the communication module and to add the read-out first reply mail to a second reply mail in creating the second reply mail as a reply mail to a second reception mail that is received before sending the first reply mail, if a portion of a body or a title of the first reception mail or the first reply mail is included in a body or a title of the second reception mail.

4. The communication apparatus of claim 1, further comprising a display,
wherein the controller adds the read-out first reply mail to the second reply mail by pasting the first reply mail to a creation screen of the second reply mail displayed on the display.

5. The communication apparatus of claim 2, further comprising a display,
wherein the controller adds the read-out first reply mail to the second reply mail by pasting the first reply mail to a creation screen of the second reply mail displayed on the display.

6. The communication apparatus of claim 3, further comprising a display,
wherein the controller adds the read-out first reply mail to the second reply mail by pasting the first reply mail to a creation screen of the second reply mail displayed on the display.

7. The communication apparatus of claim 1, wherein, if the first reception mail or the first reply mail has plural destination addresses, the controller adds the plural destination addresses to a destination address of the second reply mail according to an instruction given through the input module.

8. The communication apparatus of claim 2, wherein, if the first reception mail or the first reply mail has plural destination addresses, the controller adds the plural destination addresses to a destination address of the second reply mail according to an instruction given through the input module.

9. The communication apparatus of claim 3, wherein, if the first reception mail or the first reply mail has plural destination addresses, the controller adds the plural destination addresses to a destination address of the second reply mail according to an instruction given through the input module.

10. The communication apparatus of claim 4, wherein, if the first reception mail or the first reply mail has plural destination addresses, the controller adds the plural destination addresses to a destination address of the second reply mail according to an instruction given through the input module.

11. The communication apparatus of claim 1, wherein:
the memory comprises a first memory and a second memory; and
the controller adds the read-out first reply mail to the second reply mail by reading the first reply mail stored in the first memory and adds the read-out first reply mail to the second reply mail stored in the second memory, in creating the second reply mail using the input module.

12. The communication apparatus of claim 2, wherein:
the memory comprises a first memory and a second memory; and
the controller adds the read-out first reply mail to the second reply mail by reading the first reply mail stored in the first memory and adds the read-out first reply mail to the second reply mail stored in the second memory, in creating the second reply mail using the input module.

13. The communication apparatus of claim 3, wherein:
the memory comprises a first memory and a second memory; and
the controller adds the read-out first reply mail to the second reply mail by reading the first reply mail stored in the first memory and adds the read-out first reply mail to the second reply mail stored in the second memory, in creating the second reply mail using the input module.

14. The communication apparatus of claim 4, wherein:
the memory comprises a first memory and a second memory; and
the controller adds the read-out first reply mail to the second reply mail by reading the first reply mail stored in the first memory and adds the read-out first reply mail to the second reply mail stored in the second memory, in creating the second reply mail using the input module.

15. The communication apparatus of claim 5, wherein:
the memory comprises a first memory and a second memory; and
the controller adds the read-out first reply mail to the second reply mail by reading the first reply mail stored in the first memory and adds the read-out first reply mail to the second reply mail stored in the second memory, in creating the second reply mail using the input module.
